(19) United States
(12) Patent Application Publication
(10) Pub. No.: US 2011/0053811 A1
(43) Pub. Date: Mar. 3, 2011

(54) METHODS FOR PREVENTING OR REMEDIATING XANTHAN DEPOSITION

(75) Inventors: Robert L. Horton, Sugar Land, TX (US); Michael T. Darring, New Orleans, LA (US); Hiram Molina, Destrehan, LA (US)

(73) Assignee: M-I L.L.C., Houston, TX (US)

(21) Appl. No.: 12/863,072

(22) PCT Filed: Jan. 8, 2009
(86) PCT No.: PCT/US09/30378

§ 371 Date: Jul. 15, 2010

Related U.S. Application Data
(60) Provisional application No. 61/021,554, filed on Jan. 16, 2008.

(51) Int. Cl. C09K 8/524

(52) U.S. Cl. 507/213; 507/200; 507/241

(57) ABSTRACT

Methods for remediation and/or prevention of polymer deposition on surfaces, in particular, on surfaces of drilling machinery and earth formations in the petroleum industry are described herein. Embodiments disclosed herein relate to a method of remediating xanthan deposition, the method including the steps of contacting xanthan deposition, including xanthan complexed with polyvalent metal ions, with a remediation fluid containing at least one chelating agent; and allowing the fluid to dissolve the xanthan deposition. Also disclosed is a method of preventing polymer deposition, including emplacing a wellbore fluid including a crosslinkable polymer and at least one chelating agent in a wellbore; wherein the at least one chelating agent complexes with polyvalent metal ions present in the wellbore. Also disclosed is an improved wellbore fluid including a base fluid; a polymer comprising chemical groups reactive to polyvalent metal ions found downhole; and at least one chelating agent; wherein the least one chelating agent complexes with polyvalent metal ions downhole.

### BACKGROUND OF INVENTION

1. Field of the Invention

Embodiments disclosed herein relate generally to methods for remediation and/or prevention of polymer deposition on surfaces, in particular, on surfaces of drilling machinery and earth formations in the petroleum industry. Even more particularly, embodiments disclosed herein relate to methods for the remediation and/or prevention of the deposition of xanthan on surfaces of drilling machinery and earth formations in the petroleum industry.

2. Background Art

When drilling or completing wells in earth formations, various fluids typically are used in the well for a variety of reasons. For the purposes herein, these fluids will be generically referred to as “wellbore fluids.” Common uses for wellbore fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, minimizing fluid loss into the formation after the well has been drilled and during completion operations such as, for example, perforating the well, replacing a tool, attaching a screen to the end of the production tubulars, gravel-packing the well, or fracturing the formation in the vicinity of the well, displacing the fluid within the well with another fluid, cleaning the well, testing the well, emplacing a packer and packer fluid, abandoning the well or preparing the well for abandonment, and otherwise treating the well or the formation.

Depending on the particular application or well to be drilled, a drilling operator typically chooses between a water-based wellbore fluid and an oil-based or synthetic wellbore fluid. Each of the water-based fluid and oil-based fluid typically include a variety of additives to create a fluid having the rheological profile suitable for a particular drilling application. For example, a variety of compounds are typically added to water- or brine-based wellbore fluids, including viscosifiers, corrosion inhibitors, lubricants, pH control additives, surfactants, solvents, thinning agents, and/or weighting agents, among other additives.

Viscosifiers are used to enhance viscosity, thereby providing wellbore fluids with the rheological profiles that enable wells to be drilled more easily. Viscosifiers are typically clays, polymers and oligomers, and may be either synthetic or natural. Some typical water- or brine-based wellbore fluid viscosifying additives include clays, synthetic polymers, natural polymers and derivatives thereof. Similarly, a variety of compounds are also typically added to a oil-based fluid including weighting agents, wetting agents, organophilic clays, viscosifiers, fluid loss control agents, surfactants, dispersants, interfacial tension reducers, pH buffers, mutual solvents, thinners, thinning agents and cleaning agents.

Examples of synthetic polymers and oligomers that can be used as viscosifiers include poly(ethylene glycol) [PEG], poly(diallyl amine), poly(acrylamide), poly(aminomethylpropylsulfonate) [AMPS polymer], poly(acrylonitrile), poly(vinyl acetate) [PVA], poly(vinyl alcohol) [PVOH], poly(vinyl amine), poly(vinyl sulfonate), poly(styryl sulfonate), poly(acrylate), poly(methyl acrylate), poly(methacrylate), poly(methyl methacrylate), poly(vinylpyrrolidone), poly(vinyl lactam), and co-, ter-, and quater-polymers of the following co-monomers: ethylene, butadiene, isoprene, styrene, divinylbenzene, divinyl amine, 1,4-pentadiene-3-one (divinyl ketone), 1,6-heptadiene-4-one (diallyl ketone), diallyl amine, ethylene glycol, acrylamide, AMPS, acrylonitrile, vinyl acetate, vinyl alcohol, vinyl amine, vinyl sulfonate, styryl sulfonate, acrylate, methyl acrylate, methacrylate, methyl methacrylate, vinylpyrrolidone, and vinyl lactams.

Natural polymers and derivatives thereof such as xanthan gum, guar gum, and hydroxyethyl cellulose (HEC) may also be used as wellbore fluid viscosifying additives. In addition, a wide variety of polysaccharides and polysaccharide derivatives may be used, as is well known in the art. These polysaccharides are typically used to enhance viscosity in fresh water, seawater, brines, saturated brines, lignosulfate, or heavy mud systems.

Synthetic polymers, for example, polyacrylamides, have been found to suffer such deficiencies as viscosity loss in brines and severe shear sensitivity. Because, as has been well documented in the prior art, xanthan is relatively insensitive to salts (does not precipitate or lose viscosity under normal conditions), is shear stable, thermostable and viscosity stable over a wide pH range, xanthan is a good choice of a viscosifying additive. Moreover, xanthan is not adsorbed on the elements of the porous rock formations to the extent of causing permanent productivity reduction, and it gives viscosities (5 to 100 centipoise units at 7.3 sec.⁻¹ shear rate) at low concentrations (100 to 3000 ppm) useful for wellbore fluids and in enhanced oil recovery. The use of solutions of xanthan or derivatives of xanthan in wellbore fluids is described in U.S. Pat. Nos. 3,243,000; 3,198,268; 3,532,166; 3,305,016; 3,251,417; 3,319,606; 3,319,715; 3,373,810; 3,434,542; 3,729,460 and 4,119,546.

Accordingly, there exists a continuing need for development related to wellbore fluids containing xanthan therein.

### SUMMARY OF INVENTION

In one aspect, embodiments disclosed herein relate to a method of remediating xanthan deposition, the method including the steps of contacting xanthan deposition, including xanthan complexed with polyvalent metal ions, with a remediation fluid containing at least one chelating agent; and allowing the fluid to dissolve the xanthan deposition.

In another aspect, embodiments disclosed herein relate to a method of preventing polymer deposition, including emplacing a wellbore fluid including a crosslinkable polymer and at least one chelating agent in a wellbore; wherein the at least one chelating agent complexes with polyvalent metal ions present in the wellbore.

In yet another aspect, embodiments disclosed herein relate to an improved wellbore fluid including a base fluid; a polymer comprising chemical groups reactive to polyvalent metal ions found downhole; and at least one chelating agent; wherein the least one chelating agent complexes with polyvalent metal ions downhole.

Other aspects and advantages of the invention will be apparent from the following description and the appended claims.

### DETAILED DESCRIPTION

Generally, embodiments disclosed herein relate to methods of remediating or preventing xanthan deposition. More specifically, embodiments disclosed herein relate to dissolving and/or preventing the formation of deposited xanthan scale on oilfield equipment, in a wellbore, and on the earthen formation. More specifically still, embodiments disclosed herein relate to methods of dissolving xanthan scale in which the active chelating agent may be reclaimed for further use.

The inventors have advantageously found that the addition of a chelating agent to a wellbore fluid prevents the buildup of polymer scale in the wellbore, on the earthen formation and on downhole equipment. The inventors have further advantageously found that the use of a remediation fluid comprising a chelating agent removes polymer scale from the wellbore, on the downhole equipment and earthen formation. As used herein, “chelating agent” is a compound whose molecular structure can envelop and/or sequester a certain type of ion in a stable and soluble complex. When sequestered inside the complex, the cations have a limited ability to react with other ions, clays or polymers, for example.

Frequently, a wellbore fluid may contain a polymer capable of complexing with polyvalent metal ions found in the wellbore and in earthen formation, and which has been observed to form polymer scale when drilling through formations of that type. In some embodiments, it has been found that the addition of particular chelating agents to a wellbore fluid may prevent the buildup of polymer scale in the wellbore, on downhole equipment, or on or within the formation itself. For example, chelating agents may be added to a wellbore fluid used in the normal course of drilling or oil recovery. The improved wellbore fluid may then be used in drilling or in oil recovery operations. Improved wellbore fluids of the present disclosure containing chelating agents may prevent the buildup of polymer scale in the wellbore, on the downhole equipment and on the earthen formation. The present disclosure addresses any scale that is or may be induced by the interaction of polyvalent metal ions and xanthan or other polymers regardless of the source of the polyvalent metal ions.

In other embodiments, it has been found that the use of a remediation fluid comprising a chelating agent can remove polymer scale from the wellbore, on downhole equipment, or on the formation itself. For example, after polymer scale has been observed on the equipment, or thought to exist on the formation, a remediation fluid of the present disclosure may be introduced downhole. The remediation fluid may then remove the polyvalent ions from the crosslinked polymer, allowing the polymer to return to its fluid, un-crosslinked state. The polymer may then be recycled into the wellbore fluid for circulation or other use in the wellbore. Alternatively, the remediation fluid may be used to remove polymer scale from equipment in need of repair.

Polymers used as components of wellbore fluids in downhole applications, as mentioned above, include both synthetic and natural polymers. Included among those polymers used in the wellbore are some polymers which possess reactive groups capable of interacting with polyvalent ions found downhole, causing crosslinking or some type of gelation of the polymer.

For example, xanthan is a polymer frequently used in well fluids. Xanthan is a high molecular weight biopolymer that may be produced by the bacterium Xanthomonas campestris, and precipitated from the fermentation broth, usually by an alcohol. Structurally, xanthan is a heteropolysaccharide, the backbone consisting of D-glucose repeating units that are bonded together by 1,4-β-glucosidic linkages. The glucan backbone is protected by trisaccharide side chains attached by β-1,3-glycosidic or mannosidic linkages. The trisaccharide side chains consist of mannose and glucuronic acid moieties. This structure is represented as below:

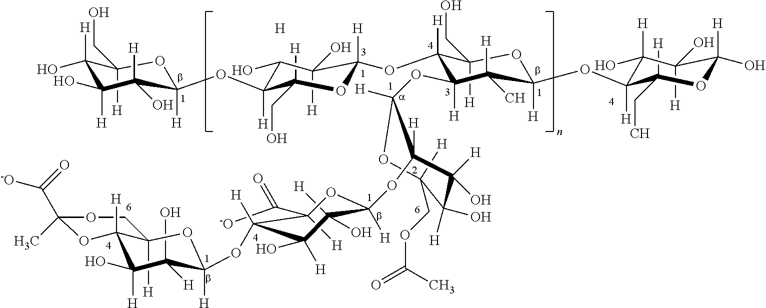

Each molecule consists of about 7000 pentamers. The trisaccharide mannose and glucuronic acid side chains lend rigidity to the xanthan molecule, and allow it to form a right-handed helix. Its natural state has been proposed to be bimolecular antiparallel double helices. The helicity of the xanthan molecule facilitates its interaction with itself and with other long chain molecules to form thick mixtures and gels in water.

Xanthan may be used in a variety of industrial applications, for example, as described in U.S. Pat. No. 4,119,546. Typical well applications include, but are not limited to, those mentioned above, most typically as a brine thickener in drilling muds and workover fluids, as a viscosifier in hydraulic fracturing, cementing, and other well completion operations, as a proppant carrier or gel blocking agent in gravel packing and frac packing operations, in secondary and tertiary recovery operations, and in non-petroleum-producing applications such as a clarifier for use in refining processes. Although the application uses xanthan as an example throughout, one of skill in the art would recognize that the wellbore fluids and remediation fluids of the present disclosure may be used with any polymer capable of interacting with polyvalent ions to result in crosslinking or gelation.

In applications where xanthan is used as a viscosifier in wellbore fluids, the wellbore fluid may be prepared in a large variety of formulations. Specific formulations may depend on the state of drilling a well at a particular time, for example, depending on the depth and/or the composition of the formation. The amount of xanthan gum in the wellbore fluid may be varied to provide the desired viscosity. In one embodiment, the xanthan gum may range from about 0.1 to about 7.0 wt % of the total weight of the wellbore fluid. In another embodiment, xanthan gum in addition to other any other included polymers, may range from about 0.2 to 2.0 wt % of the total weight of the wellbore fluid, and from 0.3 to 1.0 wt % in yet another embodiment.

The wellbore fluid composition described above may be adapted to provide improved wellbore fluids under conditions of high temperature and pressure, such as those encountered in deep wells. Further, one skilled in the art would recognize that, in addition to xanthan gum, other additives may be included in the wellbore fluid disclosed herein, for instance, wetting agents, organophilic clays, corrosion inhibitors, oxygen scavengers, anti-oxidants and free radical scavengers, biocides, weighting agents, other viscosifiers, surfactants, dispersants, interfacial tension reducers, pH buffers, mutual solvents and thinning agents.

However, some of these polymer viscosifiers are believed to form scale in the wellbore, on the surfaces of downhole equipment and on the formation because they may be easily be precipitated by crosslinking with metal ions, which exist in may circumstances plentifully in the downhole environment. For instance, xanthan biopolymer has carboxylic groups which can serve as cross-linking sites for polyvalent metal ions such as iron, magnesium and calcium. These metal ions are commonly found in oil-bearing formation waters.

Xanthan-containing fluids are known to cause damage to the permeability of the near wellbore area due to mud or scale buildup on the formation faces and on the surfaces of any downhole equipment. When the wellbore fluid is supplied downhole during drilling operations, at least part of xanthan gum contained in the wellbore fluid may crosslink with polyvalent metal cations in the downhole environment.

Polyvalent metal cations which crosslink xanthan gum may stem from minerals naturally present in the subterranean formations, from metallic substances in oilfield equipment, or from base fluids used in formulating wellbore fluids (e.g., from brines). Nonlimiting examples of such metal cations include aluminum, iron, zirconium, calcium, and chromium. For instance, Fe(II)/Fe(III) cations are dissolved from iron-containing minerals and solids in the downhole environment, and then they may crosslink with xanthan gum to form scale. As a result, xanthan gum crosslinked with Fe(II)/Fe(III) cations may form an insoluble solid deposition or scale on the formation and/or oilfield equipment.

The result of this crosslinking is biopolymer immobilization and formation plugging due to a gelation mechanism. Heavy metal ions such as Cr³⁺, Al³⁺, Fe²⁺, Ca²⁺ and Fe³⁺ are well known to cause gelation of xanthan. There are also other ions which may complex with xanthan in certain pH intervals. Xanthan gelation is thought to occur via the carboxylic groups, and the mechanism of gelation does not appear to selectively favor any polyvalent ion over others. The crosslinking reaction is thought to be a ligand exchange reaction where water molecules coordinated to the heavy metal ion are exchanged for the carboxylic groups of the xanthan polymer. The polyvalent heavy metal ion may complex to several carboxylic groups of the xanthan backbone causing the xanthan polymer chain to crosslink with itself, or with other polymer chains forming an insoluble scale or gel.

When used in polymer flooding, oil production is thus reduced because the xanthan cannot readily migrate through the rock formation. Similarly, scale deposits can also result in plugging of well bores, well casing perforations and tubing strings, as well as sticking of downhole safety valves, downhole pumps and other downhole and surface equipment and lines.

In general, it is undesirable that such scale is formed downhole because the encrustation must be removed in a time- and cost-efficient manner. For example, plugged tubing and equipment has to be removed and replaced. Alternatively, scale is removed from contaminated tubing and equipment through equipment decontamination processes. This results in significant costs in terms of equipment costs, man-hours, and downtime.

On the surface, typical equipment decontamination processes include both mechanical and chemical efforts, such as milling, high pressure water jetting, sand blasting, cryogenic immersion, and chemical solvents. For instance, water jetting using pressures in excess of 140 MPa (with and without abrasives) can be effective for scale removal. However, use of mechanical methods such as high pressure water jetting generally requires that each pipe or piece of equipment be treated individually with significant levels of manual intervention, which is both time consuming and expensive, and sometimes also fails to thoroughly treat the contaminated area. Alternatively, chemical processes may include contacting scale with a chemical solvent such that the chemical solvent can dissolve the scale. However these techniques are limited to the surface and do not solve problems associated with deposition formed in the wellbore.

A common prior art approach to removing xanthan scale has been to apply acid or strong oxidative breaker systems to dissolve the xanthan gum. A typical wellbore treatment to remove such damage consists of hydrochloric acid solutions, solutions of lithium or sodium hypochlorite, or highly concentrated solutions of conventional oxidizers like sodium or ammonium persulfate or perborate. Although acids and oxidative solution washes appear to perform reasonably well in a laboratory environment where contact of scale with a reactive solution is easily achieved, application of these solutions may not be so effective for removing the damage in horizontal intervals. Additional concerns regarding the use of acidic or oxidative cleanup treatments include the reactivity with tubulars which may result and elevated iron concentrations being injected into the reservoir in a manner which may promote sludging problems and exacerbate the scale issue. As such, conventional acid and oxidizer treatments are typically ineffective to remove or mitigate xanthan scale due to the resistance of xanthan towards oxidizers and acids. Further, conventional chemical processes require the disposal of solvents once saturated, and the large amount of fairly expensive solvents necessary for decontamination may be associated with increased costs and environmental and safety concerns.

Well treatments using xanthan-specific enzymes have been proposed to treat xanthan polymer buildup. However, these treatments employ enzymes that are typically not effective at temperatures greater than about 150° F. Because many wells have downhole temperatures exceeding 150° F., proposed enzyme treatments for removing xanthan scale would be ineffective in many wells having temperatures exceeding this level.

Further, the glucan backbone of the xanthan biopolymer is protected by the trisaccharide side chains which lie alongside, making it relatively stable to acids, alkalis and enzymes. This presents an on-going challenge to remediate or prevent xanthan deposition. Accordingly, there exists a continuing need for a more effective means for removing scale that results from crosslinking of polysaccharides and polysaccharide derivatives with polyvalent metal ions.

Scale that may be effectively removed from oilfield equipment in embodiments disclosed herein includes oilfield scales containing xanthan gum, for example, scale containing xanthan gum crosslinked with polyvalent metal cations.

As mentioned above, the inventors have advantageously found that the addition of a chelating agent to the wellbore fluid prevents the formation of polymer scale or removes polymer scale in the downhole environment. Chelating agents useful in the embodiments disclosed herein sequester polyvalent metal ions through bonds to two or more atoms of the chelating agent. Useful chelating agents may include organic ligands such as ethylenediamine, diaminopropane, diaminobutane, diethylenetriamine, triethylenetetraamine, tetraethylenepentamine, pentaethylenehexamine, tris(aminoethyl)amine, triaminopropane, diaminoaminoethylpropane, diaminomethylpropane, diaminodimethylbutane, bipyridine, dipyridylamine, phenanthroline, aminoethylpyridine, terpyridine, biguanide and pyridine aldazine.

In some embodiments, the chelating agent that may be used in the solution to dissolve the metal scale may be a polydentate chelator such that multiple bonds are formed with the complexed metal ion. Polydentate chelators suitable may include, for example, ethylenediaminetetraacetic acid (EDTA), diethylenetriaminepentaacetic acid (DTPA), nitrilotriacetic acid (NTA), ethyleneglycoltetraacetic acid (EGTA), 1,2-bis(o-aminophenoxy)ethane-N,N,N′,N′-tetraaceticacid (BAPTA), cyclohexanediaminetetraacetic acid (CDTA), triethylenetetraaminehexaacetic acid (TTHA), glutamic-N,N-diacetic acid (GLDA), salts thereof, and mixtures thereof. However, this list is not intended to have any limitation on the chelating agents suitable for use in the embodiments disclosed herein. One of ordinary skill in the art would recognize that selection of the chelating agent may depend on the metal scale to be dissolved. In particular, the selection of the chelating agent may be related to the specificity of the chelating agent to the particular scaling cation, the log K value, the optimum pH for sequestering and the commercial availability of the chelating agent, as well as downhole conditions, etc.

In a particular embodiment, the chelating agent used to dissolve metal scale is EDTA or salts thereof. Salts of EDTA may include, for example, alkali metal salts such as a tetrapotassium salt or tetrasodium salt. However, as the pH of the dissolving solution is altered in the processes disclosed herein, a dipotassium or disodium salt or the acid may be present in the solution. EDTA is an amino acid, as shown below, with four carboxylate and two amine groups. This polydentate chelator is typically used to sequester di- and trivalent metal ions, for example Mn(II), Cu(II), Fe(III), and Co(III).

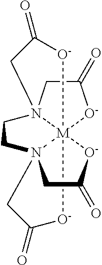

Wellbore fluids of embodiments of this disclosure containing chelating agents may be emplaced in the wellbore using conventional techniques known in the art. If used as a preventative additive, the chelating agent may be added to the drilling, completion, or workover fluid. If, however, remediation of a particular interval of the wellbore is needed, a remediation fluid including a chelating agent may be injected to such interval, in addition to other intervals. The wellbore fluid may contain an amount of chelating agent sufficient to prevent polymer crosslinking, or alternatively to remediate polymer crosslinking. The wellbore fluids may be used in conjunction with any drilling, completion, or production operation.

As the wellbore fluid encounters polyvalent ions, the chelating agent may complex with the polyvalent ion to form a chelated complex. The bonds between the sequestered polyvalent ion and the chelating agent may be any combination of coordination or ionic bonds. The resultant chelated complex has enhanced stability through the chelant effect, relative to crosslinking with the reactive groups of the polymer, for example the carboxylic groups of the xanthan biopolymer.

In embodiments where the chelating agent is part of the wellbore fluid, in which xanthan is included, the polyvalent ions may preferably react with the chelating agent to form a stable chelated complex. The stable chelated complex may be thermodynamically and/or kinetically favored to the crosslinked polymer. As such, the deposition of polymer scale in the wellbore may be significantly decreased, thereby promoting well stability and productivity.

In embodiments where the chelating agent is part of a remediation fluid, the polyvalent ions crosslinked to the polymer may release on favorable interaction and complexation with the chelating agent. As the remediation fluid containing the chelating agent encounters polymer-bound polyvalent ions, the ions may preferentially dissociate from the polymer and complex with the chelating agent. As the polymer releases the bound polyvalent ions to the remediation fluid, the polymer scale dissolves, and the polymer then may return to its fluid, pseudoplastic state.

Following use in preventing/remediating polymer deposition, the wellbore fluids may be collected and subjected to reclamation techniques typically used with wellbore fluids. Additionally, it may be desirable to remove the chelating agent from a collected aqueous portion of a fluid. Once the chelating agent becomes saturated with the metal cations, the wellbore fluid or remediation fluid may then be removed and recycled. One suitable method for recycling used chelating agents is described in U.S. patent application Ser. No. 11/690,660, which is assigned to the assignee of the present disclosure. That application is incorporated by reference in its entirety.

In some embodiments disclosed herein, the remediation solution may possess a dissolution capacity of at least 70 grams of scale per liter of remediation solution. In other embodiments, the remediation solution may possess a dissolution capacity of at least 80 grams of scale per liter of remediation solution.

### Exemplary Embodiment

In one embodiment, an aqueous solution of 5000 ppm of FeCl₂ and an aqueous xanthan gum solution at 2 ppb with a pH ranging from 9 to 10 are prepared. 50 ml of the xanthan gum solution is taken, and is added in the FeCl₂ solution drop by drop until precipitants can be observed. The precipitants include iron-crosslinked xanthan, iron hydroxide, and/or mixed iron oxide-hydroxide compounds. 1 ppb of disodium EDTA is added to the xanthan solution. After the EDTA solution has substantially dissolved the precipitants, the solution may be acidified with hydrochloric acid to a pH between 0 and 1 to further break up the viscosity of the solution.

Upon isolation of the precipitated solids, a fresh solution of potassium carbonate may be added to the solids to achieve a final pH of about 6, whereby the dipotassium salt of EDTA will be formed and will be soluble at a level of about 10% by weight. After filtering the still-precipitated iron-crosslinked xanthan out of the solution, additional potassium carbonate may be added to the filtrate to bring the amount of potassium carbonate in the solution to about 15% by weight.

Advantageously, embodiments disclosed herein may provide for a process where the formation of mineral scale downhole may be prevented and where the dissolving solution may be reclaimed without loss of performance. By sequestering metal ions which may otherwise react with well fluid polymer to form polymer scale, the inactive salts remaining in the dissolving solution may be removed from the system to avoid buildup of impurities in the dissolving solution which could otherwise lead to a reduction in the rate and/or efficiency of scale prevention performance. If small quantities of chelating agent are lost in the process, small amounts may be added for subsequent reaction cycles so that recycling of the chelating agent and dissolving solution may be achieved without performance losses in dissolution rate or sequestering capacity in successive cycles.

Also, embodiments disclosed herein may provide for a process by which existing mineral scale can be removed from oilfield equipment and the wellbore. By precipitating the polymer scale and the chelating agent as an insoluble acid, the inactive salts remaining in the dissolving solution may be removed from the system to avoid buildup of impurities in the dissolving solution which could otherwise lead to a reduction in the rate and/or efficiency of scale dissolution performance.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method of remediating xanthan deposition, the method comprising the steps of:
contacting xanthan deposition comprising xanthan complexed with polyvalent metal ions with a remediation fluid comprising at least one chelating agent; and
allowing the fluid to dissolve the xanthan deposition.

2. The method of claim 1, wherein the polyvalent metal ions are derived from at least one of a downhole formation and downhole equipment.

3. The method of claim 1, wherein the polyvalent metal ions comprise at least one of Fe(II), Fe(III), Al³⁺, Zr⁴⁺, Ca²⁺ and Cr²⁺.

4. The method of claim 1, wherein the xanthan deposition contains xanthan crosslinked with at least one of Fe(II) and Fe(III) ions.

5. The method of claim 1, wherein the chelating agent comprises at least one of EDTA, DTPA, GLDA, NTA and salts thereof.

6. A method of preventing polymer deposition, comprising:
emplacing a wellbore fluid comprising a crosslinkable polymer and at least one chelating agent in a wellbore;
wherein the at least one chelating agent complexes with polyvalent metal ions present in the wellbore.

7. The method of claim 6, wherein the polymer comprises chemical groups reactive to polyvalent ions.

8. The method of claim 6, wherein the crosslinkable polymer comprises xanthan polymer.

9. The method of claim 6, wherein the chelating agent comprises at least one of EDTA, DTPA, GLDA, NTA, and salts thereof.

10. The method of claim 6, wherein the polyvalent metal ions are derived from at least one of a downhole formation, downhole equipment, and a base fluid from which the wellbore fluid was formulated.

11. The method of claim 6, wherein the polyvalent metal ions comprise at least one of Fe(II), Fe(III), Al³⁺, Zr⁴⁺, Ca²⁺ and Cr²⁺.

12. An improved wellbore fluid comprising:
a base fluid;
a polymer comprising chemical groups reactive to polyvalent metal ions found downhole; and
at least one chelating agent;
wherein the least one chelating agent complexes with polyvalent metal ions downhole.

13. The wellbore fluid of claim 12, wherein the polymer is xanthan polymer.

14. The wellbore fluid of claim 12, wherein the chelating agent comprises at least one of EDTA, DTPA, GLDA, NTA, and salts thereof.

15. The wellbore fluid of claim 12, wherein the polyvalent metal ions are derived from at least one of a downhole formation, downhole equipment, and the base fluid from which the wellbore fluid was formulated.

16. The wellbore fluid of claim 12, wherein the polyvalent metal ions comprise at least one of Fe(II), Fe(III), Al³⁺, Zr⁴⁺, Ca²⁺ and Cr²⁺.
